(19) United States
(12) Patent Application Publication
(10) Pub. No.: US 2024/0385490 A1
(43) Pub. Date: Nov. 21, 2024

(54) Modulator Arrangements

(71) Applicant: Fraunhofer-Gesellschaft zur Förderung der angewandten Forschung e.V., München (DE)

(72) Inventor: Patrick Runge, Berlin (DE)

(21) Appl. No.: 18/665,733

(22) Filed: May 16, 2024

(30) Foreign Application Priority Data
May 17, 2023 (DE) 10 2023 113 133.8

(51) Int. Cl. G02F 1/21

(52) U.S. Cl. CPC G02F 1/212; G02F 2201/063

(57) ABSTRACT

The disclosure relates to a modulator arrangement, including an optical thin film lithium niobate Mach-Zehnder modulator with a first and a second waveguide arm arranged on a substrate. The first and the second waveguide arm each include an area formed of lithium niobate; an electrode arrangement for generating an electric field which at least sectionally acts on the first and the second waveguide arm. The electrode arrangement includes a first and a second signal line as well as a first and a second ground line. The first signal line at least sectionally extends above the first waveguide arm so that the first signal line—as seen in a direction perpendicular to the substrate—is aligned with the first waveguide arm. The second ground line at least sectionally extends above the second waveguide arm so that the second ground line—as seen in a direction perpendicular to the substrate—is aligned with the second waveguide arm; and a differential driver for providing a voltage for the Mach-Zehnder modulator. A signal output of the driver is connected to the first signal line and a ground output is connected to the second ground line.

### CROSS-REFERENCE TO RELATED APPLICATION

This application claims priority to German Patent Application No. 10 2023 113 133.8 filed May 17, 2023, the disclosure of which is hereby incorporated by reference in its entirety.

### BACKGROUND

### 1. Technical Field

This disclosure relates to a modulator arrangement comprising a thin film lithium niobate Mach-Zehnder modulator as described herein and to a modulator arrangement comprising a thin film lithium niobate Mach-Zehnder modulator as described herein.

### 2. Technical Considerations

In recent years, Mach-Zehnder (MZ) modulators based on lithium niobate have experienced a new dynamic due to the thin film lithium niobate (TFLN) technology, as such modulators provide for a high 3 dB bandwidth and a low switching voltage (“V_TT”). Typically, TFLN-MZ modulators are driven via ground-signal-ground contacts (“Ground-Signal-Ground-Interface”). Such a Ground-Signal-Ground (GSG) interface is used as it represents a native interface for the usual push-pull configuration of the wiring of the MZ modulators. In other words, an MZ modulator classically is driven via a “single-ended” electronic unit. When the MZ modulators are used in communication networks, driving with single-ended drivers however is inefficient.

### SUMMARY

The problem underlying the disclosure therefore consists in being able to operate the MZ modulators as energy-efficiently as possible.

This problem is solved by providing the modulator arrangement with the features as described herein and the modulator arrangement with the features as described herein. Developments of the disclosure are indicated as described herein.

Accordingly, there is provided a modulator arrangement, comprising
an optical thin film lithium niobate Mach-Zehnder modulator with a first and a second waveguide arm arranged on a substrate, wherein
the first and the second waveguide arm each include an area formed of lithium niobate;
an electrode arrangement for generating an electric field which at least sectionally acts on the first and second waveguide arms, wherein
the electrode arrangement comprises a first and a second signal line and a first and a second ground line, wherein
the first signal line at least sectionally extends above the first waveguide arm so that the first signal line—as seen in a direction perpendicular to the substrate—is aligned with the first waveguide arm, wherein
the second ground line at least sectionally extends above the second waveguide arm so that the second ground line—as seen in a direction perpendicular to the substrate—is aligned with the second waveguide arm;
a differential driver for providing a voltage for the Mach-Zehnder modulator, wherein
a signal output of the driver is connected to the first signal line and a ground output is connected to the second ground line.

With the claimed electrode arrangement a reduced power consumption for example can be achieved with a high bandwidth.

The area of the MZ modulator formed of lithium niobate for example forms a waveguide core of the first and/or second waveguide arm. It is also conceivable that the area formed of lithium niobate adjoins a waveguide core of the first and/or second waveguide arm. The substrate for example consists of silicon, wherein a layer of silicon dioxide can be arranged on the substrate. The disclosure, however, is not limited to a particular configuration of the optical layers of the Mach-Zehnder modulator.

In one exemplary and non-limiting embodiment of the disclosure the area formed of lithium niobate includes at least one lithium niobate layer in a z-cut orientation.

As seen in a top view, i.e. in a direction perpendicular to the waveguide arms and parallel to the substrate, the second signal line at least sectionally extends between the first signal line and the second ground line. In addition, the first ground line-likewise as seen in a direction perpendicular to the waveguide arms and parallel to the substrate—can at least sectionally extend on a side of the first signal line facing away from the second signal line.

For example, the signal and ground lines—as seen in a direction perpendicular to the waveguide arms and parallel to the substrate—are arranged side by side in the order of first ground line, first signal line, second signal line and second ground line, i.e. in the manner of a GSSG configuration.

The driver in particular includes a further (second) signal output which is connected to the second signal line, and/or the driver includes a further (second) ground output which is connected to the first ground line. It is conceivable that the outputs of the driver are arranged side by side in the order of first ground output, first signal output, second signal output and second ground output, i.e. in a GSSG arrangement. It is possible that the signal outputs and/or the ground outputs of the driver each include a contact surface which is connected (for example bonded) to the corresponding signal lines or ground lines of the MZ modulator. It is conceivable in particular that the signal outputs and/or the ground outputs of the driver (for example the above-mentioned contact surfaces) are arranged such that they each face an end portion of the respective signal line or ground line of the MZ modulator (in particular as seen in a direction along the signal lines or ground lines).

In a second non-limiting aspect, the disclosure relates to a modulator arrangement, comprising
an optical thin film lithium niobate Mach-Zehnder modulator with a first and a second waveguide arm arranged on a substrate, wherein
the first and the second waveguide arm each include an area formed of lithium niobate, wherein the area formed of lithium niobate includes at least one lithium niobate layer in an x-cut orientation;
an electrode arrangement for generating an electric field which at least sectionally acts on the first and second waveguide arms, wherein
the electrode arrangement comprises a first and a second signal line and a first and a second ground line, wherein
the first waveguide arm—as seen in a direction perpendicular to the waveguide arms and parallel to the substrate-extends between the first ground line and the first signal line, and wherein
the second waveguide arm—as seen in a direction perpendicular to the waveguide arms and parallel to the substrate-extends between the second ground line and the second signal line;
a differential driver for generating a voltage for the Mach-Zehnder modulator, the driver including:
a first signal output which is connected to the first signal line,
a second signal output which is connected to the second signal line,
a first ground output which is connected to the first ground line, and
a second ground output which is connected to the second ground line.

For example, the signal and ground lines—as seen from above, i.e. in a direction perpendicular to the waveguide arms and parallel to the substrate—are arranged side by side in the order of first ground line, first signal line, second ground line and second signal line, i.e. in the manner of a GSGS configuration. Correspondingly, the outputs of the driver can be arranged side by side in the order of first ground output, first signal output, second ground output and second signal output. Analogously to the driver of the modulator arrangement of the first non-limiting aspect of the disclosure, the outputs of the driver in particular include contact surfaces via which a connection each exists to the corresponding signal and ground lines, respectively, of the MZ modulator.

The Mach-Zehnder modulator of the modulator arrangements of the disclosure (according to the first or the second aspect) for example includes an input waveguide connected to an input coupler. The input coupler for example is configured in the manner of an optical branching (e.g. Y-coupler), a directional coupler or an MMI (Multi Mode Interference) coupler.

It is conceivable in addition that the input waveguide comprises a first portion connected to the input coupler and a second portion via which light can be coupled into the input waveguide, wherein the input waveguide has a curvature between the first and the second portion. The second portion of the input waveguide in particular comprises an incoupling end, for example an end face (facet) of the input waveguide, via which light can be coupled into the input waveguide. For example, the curvature is a semicircle so that the curved waveguide portion connects the first portion of the input waveguide to the second portion of the input waveguide in the manner of a 180° curve. The light thus enters the input coupler in a direction which is opposite to the incoupling direction with which light can be coupled into the incoupling end of the input waveguide.

Furthermore, the Mach-Zehnder modulator can comprise at least one output coupler connected to the two waveguide arms, wherein the second portion of the input waveguide (in particular the above-mentioned incoupling end of the input waveguide) is at least partly located on a side of the output coupler facing away from the waveguide arms.

The differential driver of the modulator arrangements in particular each is configured to apply oppositely directed signals (oppositely directed electric voltages) to the signal lines. The oppositely directed signals need not necessarily have identical amplitudes. It is conceivable that the driver has two signal outputs via which the driver each provides an alternating voltage, wherein the provided alternating voltages have an opposite (oppositely directed) polarity. The differential driver in particular includes a correspondingly configured amplifier.

### BRIEF DESCRIPTION OF THE DRAWINGS

The disclosure will be explained in detail below by means of exemplary and non-limiting embodiments with reference to the Figures, in which:

FIG. 1 shows a modulator arrangement according to a first exemplary and non-limiting embodiment of the disclosure;

FIG. 2 schematically shows part of a section along A-A in FIG. 1; and

FIG. 3 shows a modulator arrangement according to a second exemplary and non-limiting embodiment of the disclosure.

### DETAILED DESCRIPTION

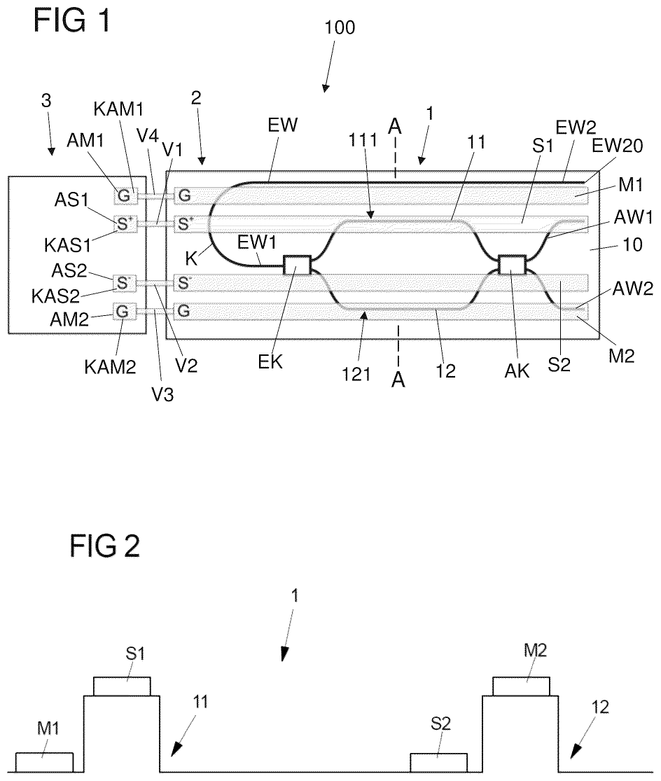

The modulator arrangement 100 according to the disclosure as shown in FIG. 1 comprises a Mach-Zehnder modulator 1 and an electrode arrangement 2 for electrically wiring the Mach-Zehnder modulator 1. The electrode arrangement 2 is coupled with a differential driver 3. The Mach-Zehnder modulator 1 comprises a first and a second waveguide arm 11, 12 arranged on a substrate 10, wherein the waveguide arms 11, 12 in a manner known per se each extend between an input coupler EK and an output coupler AK of the Mach-Zehnder modulator 1. FIG. 1 shows the modulator arrangement in a view from above, i.e. in a top view perpendicularly to the substrate 10. The waveguide arms 11, 12 need not necessarily be arranged directly on the substrate 10. Rather, the Mach-Zehnder modulator 1 can include at least one intermediate layer arranged on the substrate.

The Mach-Zehnder modulator 1 is an optical thin film lithium niobate Mach-Zehnder modulator, wherein the first and the second waveguide arm 11, 12 each include an area 111, 121 formed of lithium niobate. As already mentioned above, the area 111, 121 formed of lithium niobate for example forms a core of the first and the second waveguide arm 11, 12 or adjoins the core. The area 111, 121 formed of lithium niobate in particular has a z-cut orientation.

The electrode arrangement 2 serves for generating an electric field which at least sectionally acts on the first and the second waveguide arm 11, 12, in particular on its core. The electrode arrangement 2 comprises a first and a second signal line S1, S2 and a first and a second ground line M1, M2.

The first signal line S1 at least sectionally extends above the first waveguide arm 11 so that—as seen in a direction perpendicular to the substrate 10—it is aligned with the first waveguide arm 11. In particular, the first signal line S1 extends parallel to a straight middle portion of the first waveguide arm 11. Furthermore, the first signal line S1—both in a direction towards the driver 3 and in a direction away from the driver 3—extends beyond the waveguide arm 11.

The second ground line M2 at least sectionally extends above the second waveguide arm 12 so that—as seen in a direction perpendicular to the substrate 10—it is aligned with the second waveguide arm 12. In particular, the second ground line M2 extends parallel to a straight middle portion of the second waveguide 12 and thus parallel to the first signal line S1. Analogously to the first signal line S1, the second ground line M2 also extends beyond the waveguide arms 11, 12, namely both in a direction towards the driver 3 and in the opposite direction.

Based on the representation in FIG. 1, the second signal line S2 as seen in a vertical direction, i.e. in a direction perpendicular to the waveguide arms 11, 12 and parallel to the substrate 10, at least sectionally extends between the first signal line S1 and the second ground line M2. In particular, the second signal line S2 is parallel to the first signal line S1. The first ground line M1 extends on a side of the first signal line S1 facing away from the second signal line S2, i.e. in FIG. 1 above the first signal line S1. In other words, the signal and ground lines of the exemplary and non-limiting embodiment shown in FIG. 1—as seen in a direction perpendicular to the waveguide arms 11, 12 and parallel to the substrate 10, as seen from top to bottom in FIG. 1—are arranged side by side in the order of first ground line M1, first signal line S1, second signal line S2 and second ground line M2 (“GSSG”).

The differential driver 3 has two signal outputs AS1, AS2 and two ground outputs AM1, AM2. The first signal output AS1 is coupled with the first signal line S1 and the second signal output AS2 is coupled with the second signal line S2, wherein the driver 3 applies oppositely directed voltages to the first and the second signal line AS1, AS2. The two ground outputs AM1, AM2 are connected to the first ground line M1 and to the second ground line M2, respectively.

The connection of the driver outputs AS1, AS2, AM1, AM2 to the signal and ground lines S1, S2, M1, M2 is effected by means of connecting lines V1-V4 (for example in the form of bond wires), wherein the driver outputs AS1, AS2, AM1, AM2 each comprise a contact surface KAS1, KAS2, KAM1, KAM2 or are connected to such contact surface. Via one of the connecting lines V1-V4 the contact surfaces KAS1, KAS2, KAM1, KAM2 each are connected to an end portion of the associated signal and ground line S1, S2, M1, M2 facing the driver 3. The contact surfaces KAS1, KAS2, KAM1, KAM2 are arranged in an order which corresponds to that of the signal and ground lines S1, S2, M1, M2 (GSSG), so that the contact surfaces KAS1, KAS2, KAM1, KAM2 each face the end portion of the associated signal and ground line S1, S2, M1, M2 (as seen in the direction of the signal and ground lines S1, S2, M1, M2). The connecting lines V1-V4 can extend at least approximately parallel to each other. In particular, the connecting lines V1-V4 do not cross each other.

For coupling light into the Mach-Zehnder modulator 1 the same comprises an input waveguide EW. A first portion EW1 of the input waveguide EW is connected to the input coupler EK. The input coupler EK for example is an MMI. A second portion EW2 of the input waveguide EW is connected to the first portion EW1 via a curved portion K. The second portion EW2 has an incoupling end EW20 (for example in the form of a facet or another optical element), via which light can be coupled into the input waveguide EW. The curved portion K extends in the manner of a 180° curve, so that light can be coupled into the input waveguide EW via the incoupling end EW20 in a direction which extends opposite to the direction in which the light from the first portion EW1 enters the input coupler EK.

In addition, the Mach-Zehnder modulator 1 comprises an output coupler AK which for example likewise is configured in the form of an MMI. Two output waveguides AW1, AW2 are connected to the output coupler AK, which each have an outcoupling end via which light exits from the output waveguides AW1, AW2. The outcoupling ends of the output waveguides for example are located at least approximately at the height of the incoupling end EW20 of the input waveguide EW, i.e. the outcoupling ends of the output waveguides AW1, AW2 are aligned with the incoupling end EW20 in a vertical direction (perpendicularly to the waveguide arms 11, 12).

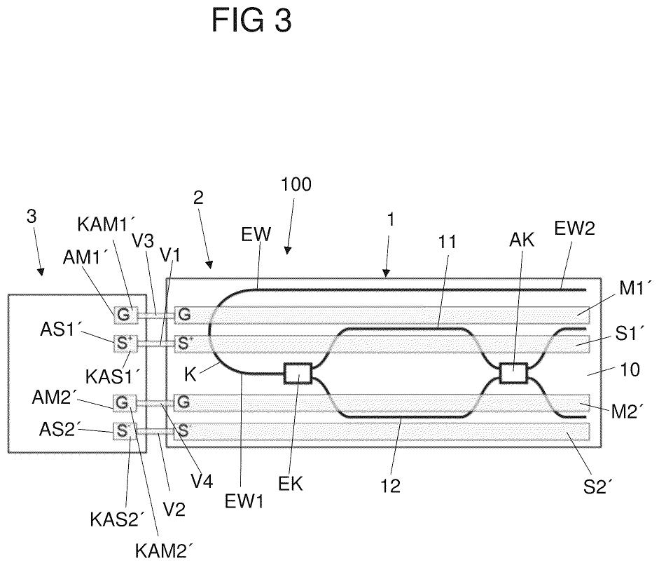

According to the representation in FIG. 2, the waveguide arms 11, 12 each comprise a rib R1, R2 on which the first signal line and the second ground line S1, M2 are arranged. Laterally beside the ribs R1, R2 the first ground line M1 and the second signal line S2 are located. In the representation of FIG. 2, the width of the first signal line S1 (at least a lower portion with which it contacts the rib R1) is smaller than the width of the associated rib R1, and also the width of the second ground line M2 is smaller than the width of the associated rib R2 (at least a lower portion of the ground line M2 with which it contacts the rib R2). The signal line S1 and the ground line M2, however, can also have at least approximately the same width as the waveguide ribs. It is also conceivable that the signal line S1 and/or the ground line M2 at least sectionally are broader than the waveguide ribs or at least broader than the waveguide cores of the respective waveguide arms 11, 12. It is also possible that the signal line S1 and/or the ground line M2 have a profile tapering towards the waveguide ribs, e.g. a trapezoidal profile. For example, such lines are seated on the waveguide rib with a narrower underside (whose width e.g. is smaller than the width of the waveguide rib or identical to the width of the waveguide rib). Accordingly, the lines in FIG. 1 (analogously in FIG. 3) can be narrower or broader than the respective waveguide rib or have a width identical to the width of the waveguide rib. The width of the signal and ground lines shown in FIGS. 1 and 3 only is exemplary.

FIG. 3 shows an alternative configuration of the electrode arrangement 2 according to the disclosure. The optical configuration of the Mach-Zehnder modulator S1 corresponds to that of FIG. 1, in particular with respect to the waveguide arms 11, 12, the input coupler EK, the output coupler AK, the input waveguide EW and the output waveguide AW. The area formed of lithium niobate also comprises at least one lithium niobate layer in an x-cut orientation.

The electrode arrangement 2 in turn has two signal lines S1′, S2′ and two ground lines M1′, M2′. The lines S1′, S2′, M1′, M2′ however are arranged differently, namely in such a way that the first waveguide arm 11—as seen in a direction perpendicular to the waveguide arms 11, 12 and parallel to the substrate 10—extends between the first ground line M1′ and the first signal line S1′. Moreover, the second waveguide arm 12 extends between the second ground line M2′ and the second signal line S2′.

Analogously to FIG. 1, the signal and ground lines S1′, S2′, M1′, M2′ each are connected to a contact surface KAS1′, KAS2′, KAM1′, KAM2′ of the driver outputs AS1′, AS2′, AM1′, AM2′. The connection likewise is effected via connecting lines V1-V4, analogously to FIG. 1. The contact surfaces KAS1′, KAS2′, KAM1′, KAM2′ as seen in a vertical direction (perpendicularly to the signal and ground lines S1′, S2′, M1′, M2′) are located side by side in the order of AM1′, AS1′, AM2′, AS2′ (from top to bottom in FIG. 3) and are located opposite the respective end portion of the associated signal and ground lines S1′, S2′, M1′, M2′ facing the driver 3, so that the connecting lines V1-V4 can extend at least approximately parallel to each other, i.e. at least crossing of adjacent connecting lines can be avoided.

Analogously to FIG. 2, the waveguide arms 11, 12 can include ribs, wherein in the exemplary embodiment of FIG. 3, however, all signal and ground lines S1′, S2′, M1′, M2′ extend beside the ribs, in particular laterally adjacent to the same. As already mentioned above, the disclosure is however not limited to a particular configuration of the optical components of the modulator arrangement 100. For example, the waveguide arms 11, 12 need not necessarily be configured as a rib waveguide.

What is claimed is:

1. A modulator arrangement, comprising
an optical thin film lithium niobate Mach-Zehnder modulator with a first and a second waveguide arm arranged on a substrate, wherein the first and the second waveguide arm each include an area formed of lithium niobate; an electrode arrangement for generating an electric field which at least sectionally acts on the first and second waveguide arms, wherein the electrode arrangement comprises a first and a second signal line and a first and a second ground line, wherein the first signal line at least sectionally extends above the first waveguide arm so that the first signal line—as seen in a direction perpendicular to the substrate—is aligned with the first waveguide arm, wherein the second ground line at least sectionally extends above the second waveguide arm so that the second ground line—as seen in a direction perpendicular to the substrate—is aligned with the second waveguide arm; and a differential driver for providing a voltage for the Mach-Zehnder modulator, wherein a signal output of the driver is connected to the first signal line and a ground output is connected to the second ground line.

2. The modulator arrangement according to claim 1, wherein the area formed of lithium niobate includes at least one lithium niobate layer in a z-cut orientation.

3. The modulator arrangement according to claim 1, wherein the second signal line—as seen in a direction perpendicular to the waveguide arms and parallel to the substrate—at least sectionally extends between the first signal line and the second ground line.

4. The modulator arrangement according to claim 1, wherein the first ground line—as seen in a direction perpendicular to the waveguide arms and parallel to the substrate—at least sectionally extends on a side of the first signal line facing away from the second signal line.

5. The modulator arrangement according to claim 1, wherein the signal and ground lines—as seen in a direction perpendicular to the waveguide arms and parallel to the substrate—are arranged side by side in the order of first ground line, first signal line, second signal line, and second ground line.

6. The modulator arrangement according to claim 1, wherein the driver comprises a further signal output which is connected to the second signal line, and/or the driver comprises a further ground output which is connected to the first ground line.

7. The modulator arrangement according to claim 6, wherein the outputs of the driver are arranged side by side in the order of first ground output, first signal output, second signal output and second ground output.

8. A modulator arrangement, comprising
an optical thin film lithium niobate Mach-Zehnder modulator with a first and a second waveguide arm arranged on a substrate, wherein the first and the second waveguide arm each comprises an area formed of lithium niobate, wherein the area formed of lithium niobate comprises at least one lithium niobate layer in an x-cut orientation; an electrode arrangement for generating an electric field which at least sectionally acts on the first and second waveguide arms, wherein the electrode arrangement comprises a first and a second signal line and a first and a second ground line, wherein the first waveguide arm—as seen in a direction perpendicular to the waveguide arms and parallel to the substrate-extends between the first ground line and the first signal line, and wherein the second waveguide arm—as seen in a direction perpendicular to the waveguide arms and parallel to the substrate-extends between the second ground line and the second signal line; and a differential driver for generating a voltage for the Mach-Zehnder modulator, the driver comprising:
a first signal output which is connected to the first signal line,
a second signal output which is connected to the second signal line,
a first ground output which is connected to the first ground line, and
a second ground output which is connected to the second ground line.

9. The modulator arrangement according to claim 8, wherein the signal and ground lines
as seen in a direction perpendicular to the waveguide arms and parallel to the substrate—are arranged side by side in the order of first ground line, first signal line, second ground line, and second signal line.

10. The modulator arrangement according to claim 9, wherein the outputs of the driver are arranged side by side in the order of first ground output, first signal output, second ground output, and second signal output.

11. The modulator arrangement according to claim 1, wherein the Mach-Zehnder modulator comprises an input waveguide connected to an input coupler.

12. The modulator arrangement according to claim 1, wherein the input waveguide comprises a first portion connected to the input coupler and a second portion via which light can be coupled into the input waveguide, wherein the input waveguide has a curvature between the first and the second portion.

13. The modulator arrangement according to claim 12, wherein the Mach-Zehnder modulator comprises at least one output coupler connected to the two waveguide arms, wherein the second portion of the input waveguide at least partly is located on a side of the output coupler facing away from the waveguide arms.

14. The modulator arrangement according to claim 1, wherein the driver is configured to apply oppositely directed signals to the first and the second signal line.

15. The modulator arrangement according to claim 1, wherein the driver comprises two signal outputs via each of which the driver provides an alternating voltage, wherein the alternating voltages provided have opposite polarity.

16. The modulator arrangement according to claim 2, wherein the second signal line—as seen in a direction perpendicular to the waveguide arms and parallel to the substrate—at least sectionally extends between the first signal line and the second ground line.

17. The modulator arrangement according to claim 2, wherein the first ground line—as seen in a direction perpendicular to the waveguide arms and parallel to the substrate—at least sectionally extends on a side of the first signal line facing away from the second signal line.

18. The modulator arrangement according to claim 3, wherein the first ground line—as seen in a direction perpendicular to the waveguide arms and parallel to the substrate—at least sectionally extends on a side of the first signal line facing away from the second signal line.

19. The modulator arrangement according to claim 2, wherein the signal and ground lines
as seen in a direction perpendicular to the waveguide arms and parallel to the substrate—are arranged side by side in the order of first ground line, first signal line, second signal line, and second ground line.

20. The modulator arrangement according to claim 3, wherein the signal and ground lines
as seen in a direction perpendicular to the waveguide arms and parallel to the substrate—are arranged side by side in the order of first ground line, first signal line, second signal line, and second ground line.
